(19) United States
(12) Patent Application Publication
(10) Pub. No.: US 2021/0064363 A1
(43) Pub. Date: Mar. 4, 2021

(54) FUNCTIONAL PROGRAMMING INTERACTIVE VISUALIZATION

(71) Applicant: MORGAN STANLEY SERVICES GROUP INC., New York, NY (US)

(72) Inventors: Stephen Goldbaum, Brooklyn, NJ (US); Attila Mihaly, New York, NY (US)

(73) Assignee: MORGAN STANLEY SERVICES GROUP INC., New York, NY (US)

(21) Appl. No.: 16/559,583

(22) Filed: Sep. 3, 2019

(51) Int. Cl. G06F 8/75; G06F 3/0482

(52) U.S. Cl. CPC G06F 8/75; G06F 3/0482

(57) ABSTRACT

A computer-implemented method for code analysis and visualization. The method comprises receiving software instructions written in a first representation; converting the first representation into a second representation, the second representation being an equivalent functional language representation of the software instructions; generating an abstract syntax tree based on the second representation; receiving a first input for the software instructions; and generating a visualization interface showing a first output of the software instructions when the software instructions are provided the first input and showing at least one attribute of the first input such that the attribute at least partially determined the first output and such that if the attribute had had a different value, an output different from the first output would have been generated by the software instructions.

### FIELD OF INVENTION

This application relates to software systems for automated code analysis and visualization, and more specifically, a visualization environment converting various instruction formats to a functional programming form to enable generation of a variety of visual formats depicting code flow and differential diagnosis of unexpected runtime output.

### BACKGROUND

When programmers create a software system or module to calculate a value or action based on user needs, such software typically acts as a black box that a user can only interact with by providing input and receiving output. A user may have no way of easily knowing why a given input produced a particular output, and if an output appears to be incorrect, the user may have no idea whether the code of the software is incorrectly written, whether it correctly encodes incorrectly provided user needs, or whether it is completely correct but is unintuitive due to interaction of rules and assumptions of the user.

User mistrust in correct programming output leads to inefficiency as users submit bug reports or communicate with programmers to request explanations, and incorrect programming in a black box-like system leads to inefficiency as users can only note a divergence between expected and actual output, without being able to better advise on where exactly an intermediate calculation may be incorrect.

Even when a programmer is acting alone to implement or debug a software system, output may be perplexing and require significant wasted time and effort to fill the code with checkpoints and debugging statements at the determination of various intermediate values, in order to determine why an output has a given value, or why two similar inputs produce different outputs.

In most software systems, written documentation of system functionality is limited to either written documents created by programmers off-line, or automatically generated documents based on comments left in the code by the programmer with a specific format. When various statements or function calls in the underlying code are changed by a programmer, there is no guarantee that any documentation referring to the code will still be accurate.

As a result of all of the above issues, software development proceeds more slowly than necessary, is less responsive to user needs or changing contexts in which the software will be executed, and often requires repeated investigations of possible or actual malfunctions that could more easily be identified for correction or dismissed as accurate functionality.

### SUMMARY OF THE INVENTION

A computer-implemented method for code analysis and visualization is disclosed. The method comprises receiving, by a computing device, software instructions written in a first representation; converting, by the computing device, the first representation into a second representation, the second representation being an equivalent functional language representation of the software instructions; generating, by the computing device, an abstract syntax tree based on the second representation; receiving, by the computing device, a first input for the software instructions; and generating, by the computing device, a visualization interface showing a first output of the software instructions when the software instructions are provided the first input and showing at least one attribute of the first input such that the attribute at least partially determined the first output and such that if the attribute had had a different value, an output different from the first output would have been generated by the software instructions.

A system for performing the methods above is also disclosed, comprising, in some embodiments, a first computing device used to input the software instructions written in the first representation and to transmit the software instructions to a second computing device, wherein the second computing device converts the first representation into the second representation and generates the visualization interface, and wherein a third computing device receives the visualization interface and displays the visualization interface to an end user.

### BRIEF DESCRIPTION OF THE DRAWINGS

Other aspects, features and advantages will become more fully apparent from the following detailed description, the appended claims, and the accompanying drawings, provided solely for purposes of illustration without restricting the scope of any embodiment:

FIG. 1 depicts a system for storing, converting, and visualizing the operation of a given software system according to methods disclosed herein;

FIG. 2 depicts a sample user interface showing a variety of data inputs and outputs to a given software system according to methods disclosed herein;

FIG. 3 depicts a method of entering and converting a set of rules into an abstract syntax tree (AST) for visualization;

FIG. 4 depicts a tree visualization generated according to methods disclosed herein;

FIG. 5 depicts a table visualization generated according to methods disclosed herein;

FIG. 6 depicts a drill-down visualization generated according to methods disclosed herein; and

FIG. 7 is a high-level block diagram of a representative computing device that may be utilized to implement various features and processes described herein.

### DETAILED DESCRIPTION

In order to address the issues described above, a system may perform code analysis and provide an end user techniques to investigate the inner workings of a piece of code—even those not specifically exposed by a programmer through debugging statements, checkpoints, or written documentation—and confirm the proper functioning of the code either in theory (a static or “theoretical” view mode that shows the relationship of variables and operations) or in practice (a dynamic or “auditing” view mode that imports actual datasets and demonstrates the process of determining software outputs when one or more items from the datasets are provided as input).

Fundamentally, a given piece of code will generally perform one of two tasks: calculation, or classification. Calculations generally involve transforming a number of input attributes mathematically into a final output value in a continuous range, such as (in examples described more fully below) determining the kinetic energy of an object based on its speed and mass, determining how much energy has been delivered in a chemical engineering process based on the temperature and other factors, or how much tax is actually assessed on a given transaction based on the tax rate and the size of the transaction. Classifications generally involve assessing a number of input attributes and, rather than mathematically transforming them, generating a discrete output value from a limited set of possible outputs, such as determining whether sensor readings from a weather post indicate a tornado, blizzard, or other meteorological event, or deciding what level of commission fee to charge a client based on a client type and other factors (but not necessarily the value of the fee as applied to the transaction).

The following paragraphs describe a system for entering arbitrary software instructions for calculation or classification of inputs, converting the software instructions into a form that better admits visualization of the software's functionality, and generating a visualization that a user can interact with to determine that a calculation or classification is being performed as expected.

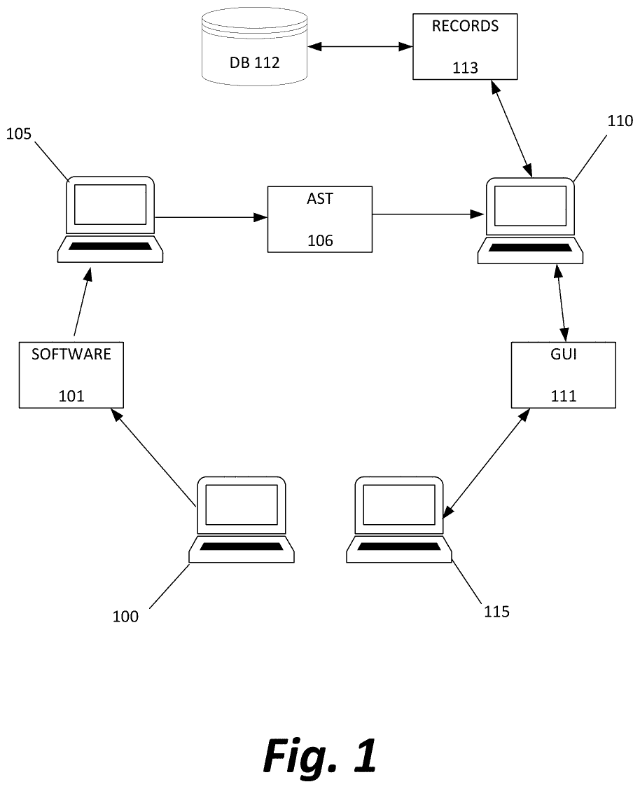

FIG. 1 depicts a system for storing, converting, and visualizing the operation of a given software system according to methods disclosed herein.

Although a system is described below in which five computing devices 100, 105, 110, 112, and 115 are treated as separate computing devices, other configurations are possible in which additional devices are added (dividing between them the functionality ascribed to a single device) or devices are removed (and in which a single general purpose computer performs multiple functionalities described below).

Initial software 101 may be written on a developer's computing device 100 in an arbitrary language. The syntax of software 101 might be, in some embodiments, declarative code written in a common programming language such as C, C++, Java, Python, SQL, or any other language, using any of a variety of paradigms (for example, object-oriented programming, an uncompiled script, a compiled program, stored procedures and queries in a database, functional programming, etc.). In other embodiments, the code might be written in a pseudocode or specialized language specifically created for a particular problem domain—for example, a series of commands in a particular API (application programming interface), or a limited domain of operators to be used in a particular software system. The specific portion of the code that will be processed will be those statements actually reflecting the mathematical operations or other logical statements that accomplish a particular calculation or classification purpose of the software; portions of code that only facilitate working with a physical machine or higher level abstractions of the machine (e.g., declaring and assigning memory for variables, performing file input/output, sending or receiving data through a network, etc.) would not be environment agnostic, and would not need to be converted to preserve the underlying logic of the software.

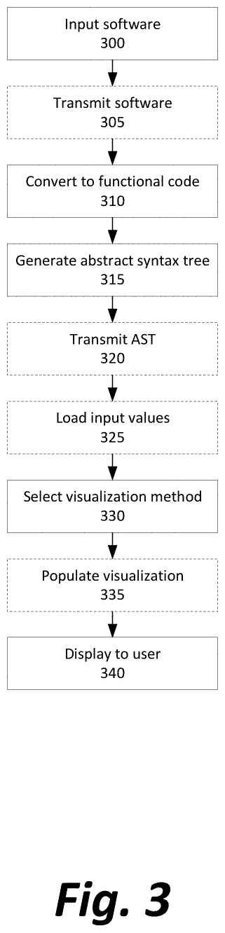

A first server computing device 105 may receive uploaded software 101 and convert it to a functional programming form and ultimately into an abstract syntax tree (AST) 106. (See more below, in the discussion accompanying FIG. 3.) The AST 106 is then transmitted to a web server 110 or other computing device.

The web server 110 or other server computing device may generate a graphical user interface (GUI) 111 for displaying and interacting with one or more ASTs and data pulled from a database server 112 when evaluating code in the “audit” mode. In a preferred embodiment, the GUI 111 is a web page accessed by a browser on the end user's computing device 115. In other embodiments, however, the GUI 111 may be generated as an independent executable, created as a Flash animation, applet, or other interactive embedded object in a web page or other generic document type, or in any other interactive form that can be displayed on any computing device.

As shown by the unidirectional and bidirectional arrows in FIG. 1, the end user may interact with the GUI 111 to pull more data from the database 112 in the “audit” mode, or may otherwise interact in such a way that GUI 111 needs to be updated and re-generated by web server 110. However, once the code 101 and AST 106 have been entered and generated, respectively, there is no need for further communication back to the modules or devices used in those steps.

As mentioned above, the functionality of devices 100, 105, 110, 112, and 115 may be consolidated into fewer devices or even a single computing device for the entire system, as necessary. For example, a single computer may have all the functionality to convert software, store a database of input records, and generate a user interface, so that it acts as devices 105, 110, and 112 with no transmission of information between devices, only passing of information between different software modules in the same device. If a programmer is testing his own work, the functionality of all five devices could be consolidated into a single development computer.

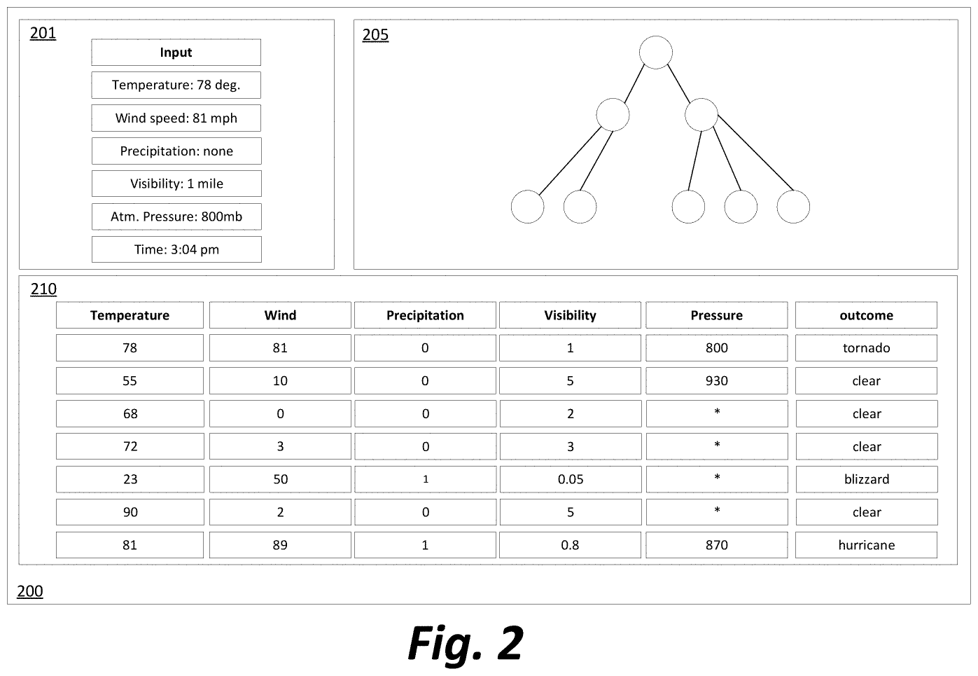

FIG. 2 depicts a sample user interface showing a variety of data inputs and outputs to a given software system according to methods disclosed herein.

In an overall user interface (UI) 200, UI region 201 may show all data for a given input, such as all column values in a database record or all attributes of an object created by software in an object-oriented paradigm.

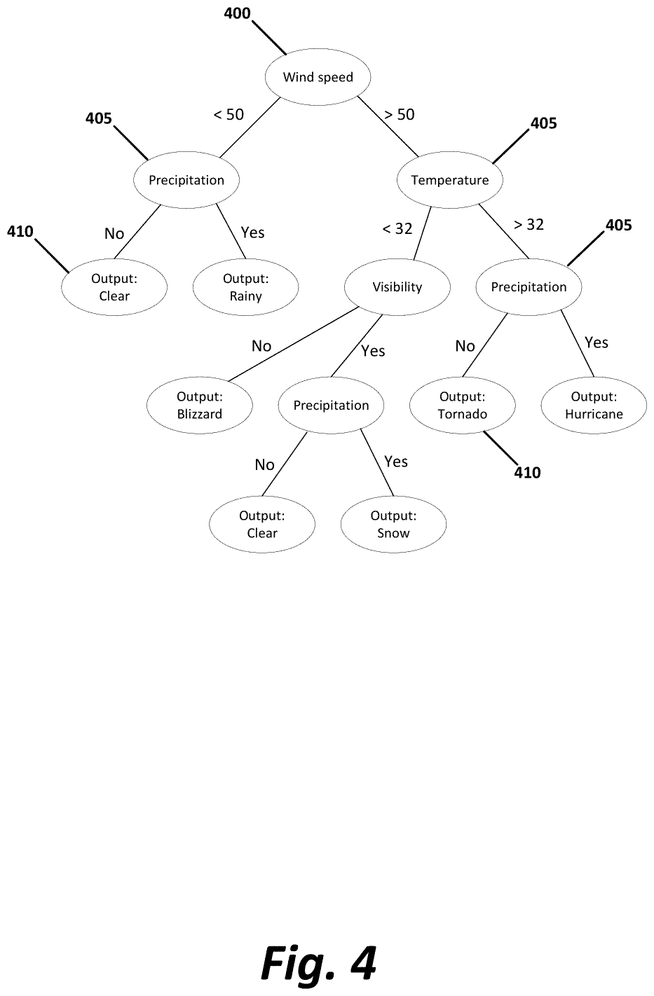

UI region 205 may show a visualization of what caused a possible output or classification of input data to occur or not occur. The discussion below, accompanying FIGS. 4-6, describes various possible visualizations of ASTs as applied to a given input.

In some embodiments, when there is database connectivity and an AST is tied to inputs drawn from a particular table of the database, UI region 210 may show a set of other data values from the table that do or do not have a same possible output or classification as the input currently being examined. For each input shown that is excluded from the output or classification, the reason for the exclusion may be displayed visually, such as a highlighting in red of a particular column value that definitively makes it impossible for that input to have the given output or classification, or a highlighting in green of one or more column values that cause the input to have the given output or classification.

FIG. 3 depicts a method of entering and converting a set of rules into an AST to provide a visualization.

Initially, a user of development computing device 100 inputs software 101, representing logic to be applied by a machine to solve a particular computation or classification problem, in a first programming syntax (Step 300). The user may type the code, cause it to be loaded from an external source, load it from a storage device, or any other way of delivering the software in a usable format.

If the functionality of development computing device 100 and server 105 not integrated into a single device, the software 101 is transmitted from device 100 to server 105 (Step 305).

Next, the software's first programming syntax is converted into a second, equivalent set of instructions expressed in a functional programming language (Step 310). The functional programming language may be lambda calculus, as lambda calculus is Turing complete and thus can perform logically equivalent tasks to those performed in any other computing language. Conversion to lambda calculus or another functional programming language also facilitates re-converting the software into any arbitrary third format different from the original format and the functional representation, and exporting the software logic as a class, function, stored procedure, or other format in any language imaginable.

Next, an abstract syntax tree (AST) is generated based on the functional language (Step 315). Because functional languages naturally define all stored values as the result of a function call, dependent on a set of other variables and calculations, nested within one another as needed, an automated parser can easily build a tree structure based on the arrangement of operators and variables in the second, functional syntax, so that the tree structure can logically represent the connections between a given variable and each of the other variables in a programming system that can influence it.

For example, if the kinetic energy of an object is known to be equal to one half the mass of the object times its speed squared, and a physics simulation program needs to calculate the kinetic energy of a simulated object, a simple AST for that function could show the final result as a root node, with branches to each of the leaves representing an input attribute (mass, or speed) that affects the outcome of the calculation. Depending on the needs of a visualization system for the AST, an AST could have nodes for only the values capable of affecting a variable's outcome, or could also have nodes for every intermediate calculation as well (for example, showing a node between the speed node and the kinetic energy node, representing speed squared, that depends on the speed node, and on which the kinetic energy node depends).

If server 105 is a different computing device from server 110, the AST is transmitted from the former to the latter (Step 320) so that the latter can use it to generate visualizations.

Next, the system may load one or more input values into memory (Step 325). As previously mentioned, in some embodiments, the visualization may have a “static” or “theory” visualization mode that only shows the relationships between variables in the program logic and does not actually operate upon possible input values, while a “dynamic” or “audit” visualization mode allows those variables to be replaced with actual input values to trace how the program actually responds to a given input.

In the audit mode, the user may be able to select and load a possible input value from database 112, or may be able to input a value with attributes the user has arbitrarily chosen as a test case to see how the software will function on the chosen input.

In one embodiment, only a single input value is loaded or entered for analysis. However, in other embodiments, two or more value may be entered in order to facilitate differentiation between two unexpectedly different outputs. For example, if two inputs seem to have very similar attributes and yet produce wildly differing outputs, a user may wish to compare the two to determine at what point in the program logic the differing attributes caused a divergence.

Based on the structure of the AST, a visualization method may be automatically selected (Step 330). There can be at least four distinct visualization types: a tree, a table, a natural language explanation, and a calculation drill-down.

A tree (illustrated in FIG. 4) can be used to illustrate either a calculation (to show the dependency of the output, the tree's root, on each of the input attributes, the tree's leaves) or a classification (to show the possible branching logic paths that represent “if/else” logic or other switches where the root is the first query used to classify the input, and each branch from the root represents a different logical path based on the response to that query). The tree can track the structure of the AST perfectly, or could in some way be derivative of the AST's structure, such as by omitting certain intermediate nodes between the root and leaves.

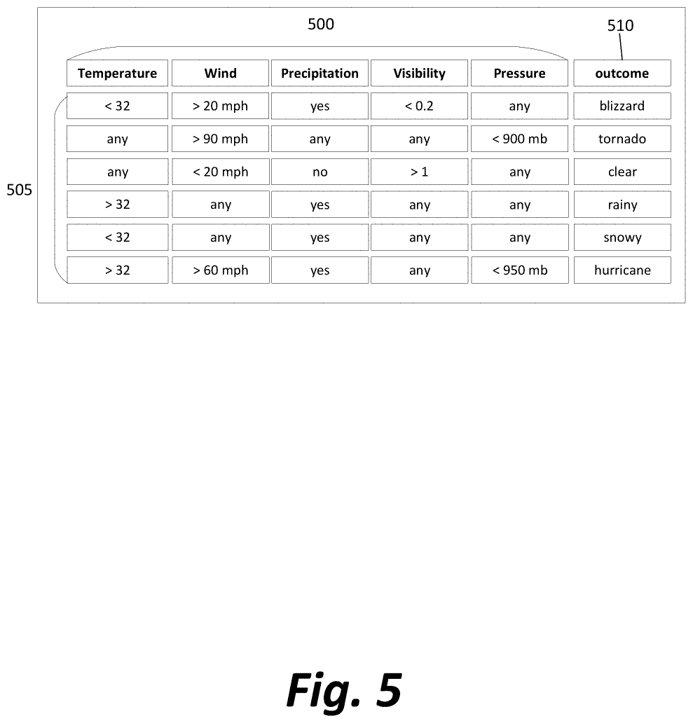

Tables (illustrated in FIG. 5) can illustrate a classification problem by showing the outcome as a final column associated with a number of input values in the preceding columns. For example, a classification of weather status may only be based on readings from a handful of sensors, allowing easy visualizations of the ranges of sensor values leading to different conclusions.

A natural language explanation can explain the same data shown in a tree or table with a more intuitive verbal explanation as a series of statements about the program logic. For example, instead of showing a classification tree for weather station input with a particular branch highlighted to show the logical path of an input, the explanation might say “Because the wind speed is greater than 50 miles per hour, and the temperature is less than 32 degrees Fahrenheit, and visibility is less than 1 mile, the current weather status is ‘blizzard’.” The explanation may also allow selection of a possible classification and explain why the input did not receive that classification: “Although wind speed is greater than 50 miles per hour, the temperature is NOT less than 32 degrees Fahrenheit, so the current weather status is not ‘blizzard’.” The explanation's text may be supplemented by coloration/highlighting, text effects (bold/italic/underline/strikethrough), icons, or other visual effects to draw attention to

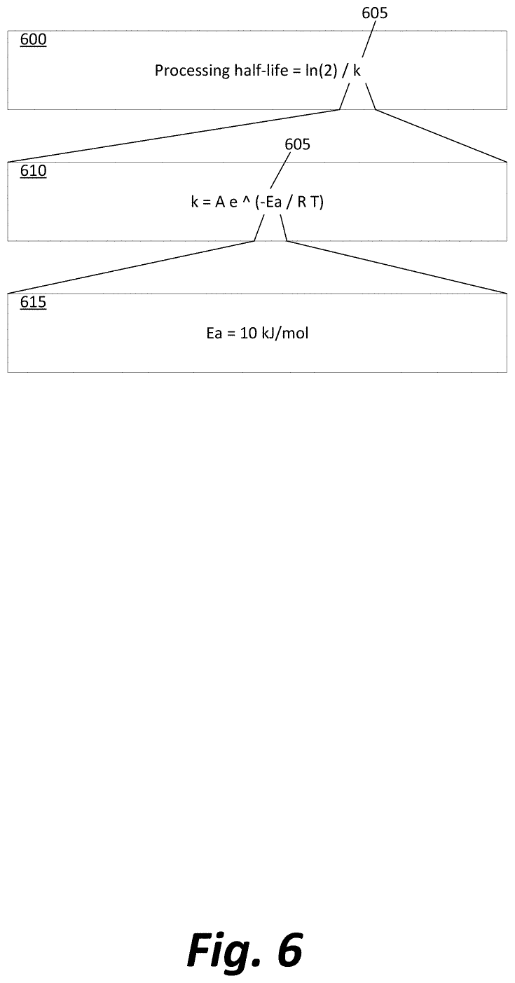

A calculation drill-down (illustrated in FIG. 6) shows a final equation 600 used to determine the output of a calculation, while allowing any variable 605 to be selected and for that variable's value or its own method of determination to be displayed. If a final calculation, as it was expressed in the original program logic, depends on a number of intermediate calculations of variables (just as determination of the amount of time left for a chemical reaction requires determination of a reaction rate from a temperature, or determination of a final tax requires calculation of a gross income, adjusted gross income, tax credits, etc.), each of these intermediate values 605 may be labeled by the visualization and clicked or otherwise selected by a user, upon which a new equation 610 is displayed, whose own variables 615 may be selected. As a result, the user is able to recursively pass through the entire logic of the calculation, regardless of its complexity.

In a preferred embodiment, each of the visualization types are generated suitable for display in a web browser, for example with HTML and Javascript to arrange the visual elements and provide interactivity to the user. In other embodiments, it is possible for a visualization to be generated as a small, independent application, as a Flash animation or other interactive embedded object, or in any other interactive form that can be displayed on a computing device.

Depending on the AST structure, the user may be able to override an automatic selection and view an AST's functionality in another selected way. For example, a tree structure that is excessively branching may be less suitable, in audit mode, than a natural language explanation of the one path an input value actually did take through the tree. In some embodiments, instead of an automatic selection, the user may simply be prompted to select a visualization, or a default visualization may be used for an application without regard to the underlying AST structure.

If in audit mode, the visualization of the AST is then populated with the attributes of the input value (Step 335) to determine the final output of the original code for that input, as well as intermediate values calculated as part of the final determination of the output.

After the visualization is generated, it is transmitted to the user's computing device (Step 340) for display and possible user interaction. The user may interact with the visualization, for example by selecting a different view type (returning to Step 330), selecting a different input to analyze in audit mode

FIG. 4 depicts a tree visualization generated according to methods disclosed herein.

In a classification system, as depicted in FIG. 4, a root node 400 may lead via links to a number of branching nodes 410, each branch being selected on the basis of satisfying a particular condition associated with the input value's attributes. Eventually, each branch of the tree terminates in a leaf node 410 that comprises a possible output of the software classifying the input.

When a tree is used in a calculation, in contrast, a number of leaf nodes 410 may each represent an attribute of the input value, so that each intermediate or branch node 405 is the result of a mathematical function of those nodes which branch off from it, leading up to the root node 400 that is the final result of all the intermediate calculations.

FIG. 5 depicts a table visualization generated according to methods disclosed herein.

Headers 500 include a number of attributes an input may have. A variety of combinations 505 of possible attribute values can each be associated with an output value 510 when the software is provided those attribute values. For example, the table of FIG. 5 roughly approximates the same decision process of the tree in FIG. 4, though instead of expressing the determination via a sequential ordering of determinations, it shows all attributes at once, allowing for ranges or for values to be undefined if they will not have a determinative effect on the output (because the equivalent classification tree would have reached a leaf node before querying the value for that specific attribute).

FIG. 6 depicts a drill-down visualization generated according to methods disclosed herein.

Initially, the graphical representation may express a final equation 600 (in this example, determining the time necessary for a chemical reaction to be completed) with references to a number of input attributes or intermediate calculations 605. Any of the intermediate calculations—for example, the “k” in equation 600—may be selected, at which point an additional equation 610 is visually displayed, showing how k is determined.

Although a specific value cannot be expanded into a determining equation, in audit mode, the specific value can be shown in a definition equation 615 if selected in any of the parent equations that rely upon it. For example, the constant Ea, which may be different in each different input, is shown for the input value currently being examined.

As mentioned previously, in any of the above visualization types, the visualization may be modified to show a divergence between two related input values that produce differing output values.

For example, in a tree visualization for classification, two trees could be placed side-by-side for each input, and color, texture, animation, or other visual cues could be used to indicate, starting at the root of each tree, which attribute values are shared (or at least still lead the program logic down the same path) and at which branch the divergence occurs. In the fee determination illustration, for example, two individuals might have the same nationality, the same client type, and then differing balance amounts that cause different fee determinations. In such a situation, two trees side by side might show the nationality and client type nodes in green, with the differing balance amounts in red to draw attention to them. Instead of green and red, other visual schemes could include shaded and unshaded, normal text and bold or italic or underlined or struckthrough text, or opaque and partially transparent, or static and blinking, or adding a halo or arrow denoting particular nodes, or any other method common to HTML or other visual interface systems for drawing attention to an element or differentiating it visually from another.

If a tree visualization is being used for a calculation, a similar visualization may be used, though naturally the nodes that are “green” or otherwise indicated as being shared will be the leaves, and a “red” or divergent branch will trace up the tree towards the root based on the attribute(s) that differed and led to different intermediate and final calculations.

In a table visualization, the overall table for the AST may be displayed, along with two additional rows for the diverging inputs. Particular column values in the additional rows that make one input impossible to be classified with the same output as the other input might similarly be indicated in red, bold, animation, etc.

In a natural language explanation of a classification, the natural language might say, for example, “Because both inputs have American nationality . . . and because both inputs have client type Premium . . . but the first input only has a balance of $1,000 and the second input has a balance of $50,000 . . . the two outputs are 2% and 1.5% respectively,” while highlighting the text of the shared values in green and of the differing values causing the divergence in red.

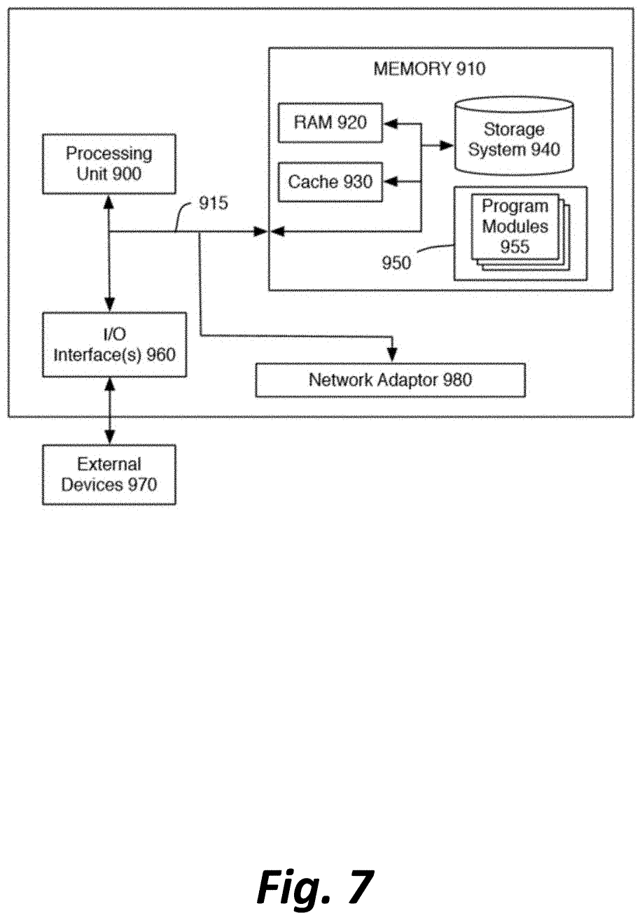

The software-implemented methods described above do not generally rely on the use of any particular specialized computing devices, as opposed to standard desktop computers and/or web servers. For the purpose of illustrating a possible such computing device, FIG. 7 is a high-level block diagram of a representative computing device that may be utilized to implement various features and processes described herein, including, for example, those of computing devices 100, 105, 110, 112 and/or 115. The computing device may be described in the general context of computer system-executable instructions, such as program modules, being executed by a computer system. Generally, program modules may include routines, programs, objects, components, logic, data structures, and so on that perform particular tasks or implement particular abstract data types.

As shown in FIG. 7, the computing device is illustrated in the form of a special purpose computer system. The components of the computing device may include (but are not limited to) one or more processors or processing units 900, a system memory 910, and a bus 915 that couples various system components including memory 910 to processor 900.

Bus 915 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Processing unit(s) 900 may execute computer programs stored in memory 910. Any suitable programming language can be used to implement the routines of particular embodiments including C, C++, Java, assembly language, etc. Different programming techniques can be employed such as procedural or object oriented. The routines can execute on a single computing device or multiple computing devices. Further, multiple processors 900 may be used.

The computing device typically includes a variety of computer system readable media. Such media may be any available media that is accessible by the computing device, and it includes both volatile and non-volatile media, removable and non-removable media.

System memory 910 can include computer system readable media in the form of volatile memory, such as random access memory (RAM) 920 and/or cache memory 930. The computing device may further include other removable/non-removable, volatile/non-volatile computer system storage media. By way of example only, storage system 940 can be provided for reading from and writing to a non-removable, non-volatile magnetic media (not shown and typically referred to as a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 915 by one or more data media interfaces. As will be further depicted and described below, memory 910 may include at least one program product having a set (e.g., at least one) of program modules that are configured to carry out the functions of embodiments described in this disclosure.

Program/utility 950, having a set (at least one) of program modules 955, may be stored in memory 910 by way of example, and not limitation, as well as an operating system, one or more application software, other program modules, and program data. Each of the operating system, one or more application programs, other program modules, and program data or some combination thereof, may include an implementation of a networking environment.

The computing device may also communicate with one or more external devices 970 such as a keyboard, a pointing device, a display, etc.; one or more devices that enable a user to interact with the computing device; and/or any devices (e.g., network card, modem, etc.) that enable the computing device to communicate with one or more other computing devices. Such communication can occur via Input/Output (I/O) interface(s) 960.

In addition, as described above, the computing device can communicate with one or more networks, such as a local area network (LAN), a general wide area network (WAN) and/or a public network (e.g., the Internet) via network adaptor 980. As depicted, network adaptor 980 communicates with other components of the computing device via bus 915. It should be understood that although not shown, other hardware and/or software components could be used in conjunction with the computing device. Examples include (but are not limited to) microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may use copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A system for code analysis and visualization, comprising:
one or more processors; and
non-transient memory storing instructions that, when executed by the one or more processors, cause the one or more processors to:
receive software instructions written in a first representation;
convert the first representation into a second representation, the second representation being an equivalent functional language representation of the software instructions;
generate an abstract syntax tree based on the second representation;
receive a first input for the software instructions; and
generate a visualization interface showing a first output of the software instructions when the software instructions are provided the first input and showing at least one attribute of the first input such that the attribute at least partially determined the first output and such that if the attribute had had a different value, an output different from the first output would have been generated by the software instructions.

2. The system of claim 1, wherein the visualization interface comprises a tree that represents a logical branching structure in the software instructions.

3. The system of claim 1, wherein the visualization interface comprises a table associating sets of possible input attribute values with possible output values.

4. The system of claim 1, wherein the visualization interface comprises a natural language explanation of at least a portion of the abstract syntax tree.

5. The system of claim 1, wherein the visualization interface comprises an interactive display of the output expressed as a series of operations on values, and wherein selection of a value causes an additional display of the calculation of that value.

6. The system of claim 1, wherein the visualization interface is provided with two inputs for which the software instructions would provide differing outputs, and wherein the visualization interface visually highlights one or more attributes of the two inputs the difference of which at least partially causes the differing outputs.

7. The system of claim 1, wherein the visualization interface loads possible inputs from a database communicatively coupled to the one or more processors for display of outputs of the software instructions for the possible inputs.

8. The system of claim 7, wherein the visualization interface displays a set of possible inputs from the database that do not produce a given output from the software instructions and visually highlights one or more attributes of the each of the set of possible inputs that cause those possible inputs not to produce the given output.

9. The system of claim 1, wherein the visualization interface is created using hypertext markup language (HTML) for display in a web browser.

10. The system of claim 1, comprising a first computing device, second computing device, and third computing device, and wherein the first computing device is used to input the software instructions written in the first representation and to transmit the software instructions to the second computing device, wherein the second computing device comprises the non-transient memory, and wherein the third computing device receives the visualization interface and displays the visualization interface to an end user.

11. A computer-implemented method for code analysis and visualization, comprising:
receiving, by a computing device, software instructions written in a first representation;
converting, by the computing device, the first representation into a second representation, the second representation being an equivalent functional language representation of the software instructions;
generating, by the computing device, an abstract syntax tree based on the second representation;
receiving, by the computing device, a first input for the software instructions; and
generating, by the computing device, a visualization interface showing a first output of the software instructions when the software instructions are provided the first input and showing at least one attribute of the first input such that the attribute at least partially determined the first output and such that if the attribute had had a different value, an output different from the first output would have been generated by the software instructions.

12. The method of claim 11, wherein the visualization interface comprises a tree that represents a logical branching structure in the software instructions.

13. The method of claim 11, wherein the visualization interface comprises a table associating sets of possible input attribute values with possible output values.

14. The method of claim 11, wherein the visualization interface comprises a natural language explanation of at least a portion of the abstract syntax tree.

15. The method of claim 11, wherein the visualization interface comprises an interactive display of the output expressed as a series of operations on values, and wherein selection of a value causes an additional display of the calculation of that value.

16. The method of claim 11, wherein the visualization interface is provided with two inputs for which the software instructions would provide differing outputs, and wherein the visualization interface visually highlights one or more attributes of the two inputs the difference of which at least partially causes the differing outputs.

17. The method of claim 11, wherein the visualization interface loads possible inputs from a database communicatively coupled to the one or more processors for display of outputs of the software instructions for the possible inputs.

18. The method of claim 17, wherein the visualization interface displays a set of possible inputs from the database that do not produce a given output from the software instructions and visually highlights one or more attributes of the each of the set of possible inputs that cause those possible inputs not to produce the given output.

19. The method of claim 11, wherein the visualization interface is created using HTML for display in a web browser.

20. The method of claim 11, wherein a first computing device is used to input the software instructions written in the first representation and to transmit the software instructions to a second computing device, wherein the second computing device converts the first representation into the second representation and generates the visualization interface, and wherein a third computing device receives the visualization interface and displays the visualization interface to an end user.
